(19) United States
(12) Patent Application Publication
(10) Pub. No.: US 2024/0141712 A1
(43) Pub. Date: May 2, 2024

(54) WINDOW DRIVING DEVICE

(71) Applicant: TOYO DENSO KABUSHIKI KAISHA, Tokyo (JP)

(72) Inventors: Taku YOSHIDA, Saitama (JP); Yosuke FUJITA, Saitama (JP); Masahiro WATANABE, Saitama (JP)

(73) Assignee: TOYO DENSO KABUSHIKI KAISHA, TOKYO (JP)

(21) Appl. No.: 18/383,527

(22) Filed: Oct. 25, 2023

(30) Foreign Application Priority Data
Oct. 31, 2022 (JP) 2022-174474

(51) Int. Cl. E05F 15/689

(52) U.S. Cl. CPC E05F 15/689; E05Y 2400/36; E05Y 2900/55

(57) ABSTRACT

A control device included by a window driving device of the present invention is configured to: when a first operation to close a window is performed with an operation device located inside a vehicle, perform first drive control including drive control to close the window at a constant first speed in a first section located on an opening side more than a closing section located near a fully closed position of the window, and drive control to close the window at a lower speed than the first speed in the closing section; and when a second operation to close the window is performed with an operation device that can be carried outside the vehicle, perform second drive control including drive control to close the window at a lower speed than the first speed in the first section.

### INCORPORATION BY REFERENCE

This application is based upon and claims the benefit of priority from Japanese patent application No. 2022-174474, filed on Oct. 31, 2022, the disclosure of which is incorporated herein in its entirety by reference.

### TECHNICAL FIELD

The present invention relates to a window driving device that drives the window of a vehicle to open and close.

### BACKGROUND ART

A device shown in Patent Literature 1 is disclosed as a window driving device that drives a window mounted on a vehicle to open and close. Patent Literature 1 describes a technique to limit the risk of occurrence of interference with a foreign object because an operator may not be able to check the surrounding conditions of the vehicle when the operator remotely operates the window. Specifically, first, in a case where the operator operates the window to close with an operation switch mounted on the vehicle, as general speeds, the device described in Patent Literature 1 drives at a constant speed V1 in a section A1 and drives at a lower speed than the previous constant speed V1 in sections A3 and A2 before a fully closed state as shown in FIG. 2A of Patent Literature 1. On the other hand, in a case where the operator remotely operates the window, when the ignition switch is off, the device drives at the abovementioned constant speed V1 in the section A1 and drives at a lower speed than the constant speed V1 in a section closer to the open-direction side than the abovementioned sections before the fully closed state as shown in FIG. 2C of Patent Literature 1. That is to say, in Patent Literature 1, the lower-speed section is set before the fully closed state in general, and the lower-speed section is set more widely on the open-direction side during remote operation.
Patent Literature 1: Japanese Patent Publication No. 6955204

However, the operator may not be able to sufficiently check the window during remote operation and, even if the abovementioned lower-speed section is set more widely, there is room for improvement in the possibility of occurrence of pinching.

### SUMMARY OF THE INVENTION

An object of the present invention is to further increase safety during remote operation of a window.

A window driving device as an aspect of the present invention includes: a driving device configured to drive a window mounted on a vehicle to open and close; and a control device configured to control the opening and closing drive on the window by the driving device. The control device is configured to: when a first operation to close the window is performed with an operation device located inside the vehicle, perform first drive control including drive control to close the window at a constant first speed in a first section located on an opening side more than a closing section located near a fully closed position of the window, and drive control to close the window at a lower speed than the first speed in the closing section; and when a second operation to close the window is performed with an operation device that can be carried outside the vehicle, perform second drive control including drive control to close the window at a lower speed than the first speed in the first section.

A window drive control method as an aspect of the present invention is a window drive control method for controlling opening and closing drive on a window mounted on a vehicle. The window drive control method includes: when a first operation to close the window is performed with an operation device located inside the vehicle, performing first drive control including drive control to close the window at a constant first speed in a first section located on an opening side more than a closing section located near a fully closed position of the window, and drive control to close the window at a lower speed than the first speed in the closing section; and when a second operation to close the window is performed with an operation device that can be carried outside the vehicle, performing second drive control including drive control to close the window at a lower speed than the first speed in the first section.

With the configurations as described above, the present invention can further increase safety during remote operation of the window of a vehicle.

### BRIEF DESCRIPTION OF DRAWINGS

FIG. 1 is a block diagram showing a configuration of a window driving device in a first example embodiment of the present invention;

FIG. 2 is a block diagram showing a configuration of a control device disclosed in FIG. 1;

FIG. 3 is a view showing a speed at the time of closing the window disclosed in FIG. 1;

FIG. 4 is a view showing a speed at the time of closing the window disclosed in FIG. 1:

FIG. 5 is a view showing a speed at the time of closing the window disclosed in FIG. 1;

FIG. 6 is a flowchart showing operation of the window driving device disclosed in FIG. 1; and

FIG. 7 is a flowchart showing operation of the window driving device disclosed in FIG. 1.

### EXAMPLE EMBODIMENT

### <First Example Embodiment.

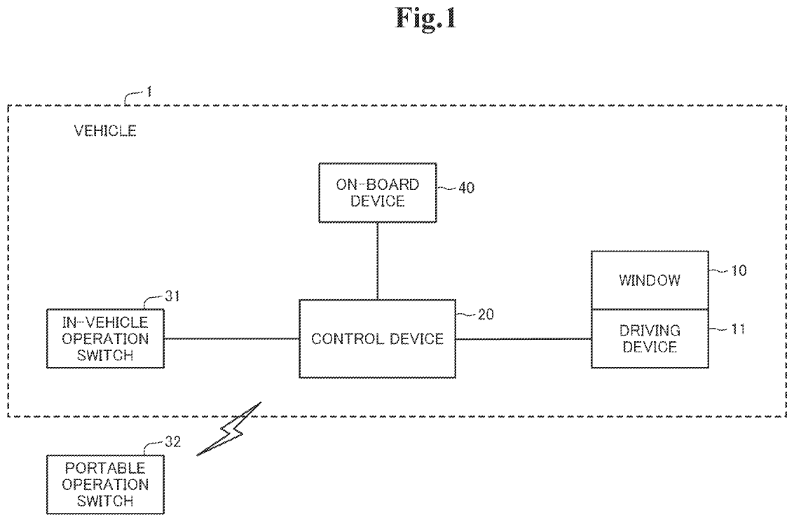

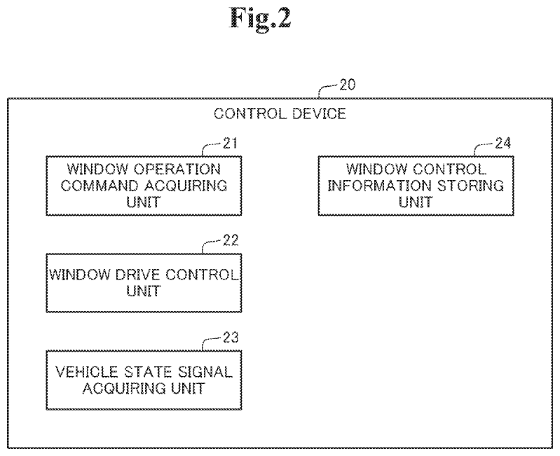

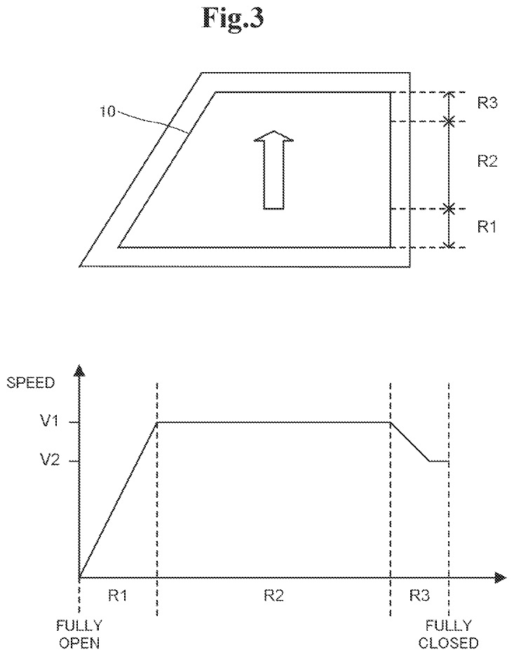

A first example embodiment of the present invention will be described with reference to FIGS. 1 to 7. FIGS. 1 and 2 are views for describing a configuration of a window driving device, and FIGS. 3 to 7 are views for describing operation of the window driving device.

### [Configuration]

The window driving device according to the present invention is a device for driving a window 10 of an automobile, which is a vehicle, to open and close. Specifically, the window driving device includes, as shown in FIG. 1, a driving device 11 that drives the window mounted on a vehicle 1 to open and close, and a control device 20 that controls the opening/closing drive of the window 10 by the driving device 11. To the control device 20, an in-vehicle operation switch 31 installed inside the vehicle 1 and a portable operation switch 32 that can be carried outside the vehicle are connected as operation devices for operating the window to open and close. Moreover, various on-board devices 40 mounted on the vehicle 1 are connected to the control device 20. The respective components will be described in detail below.

The window 10 includes windows installed on the driver's side, passenger's side, backseat sides, and the like, of the automobile that is the vehicle 1. The window 10 is driven by the driving device 11 to open and close. The driving device 11 is, for example, composed of a motor, and drives to open/close at a speed corresponding to the open/closed position of the window in accordance with a control command from the control device 20 as will be described later. In particular, in this example embodiment, a case where the driving device 11 drives the window 10 to be in a fully closed state from a fully open state, that is, to close from the bottom to the top as shown with an arrow in FIG. 3 will be described.

The in-vehicle operation switch 31 is an operation device that is installed inside the vehicle 1 and is for an operator seated on the seat of the vehicle 1 to perform an operation to open/close the window 10. The in-vehicle operation switch 31 is, for example, placed on an armrest provided on a door at a seat where the corresponding window 10 is installed. When the in-vehicle operation switch 31 accepts input of an opening/closing command through the operation by the operator on the corresponding window 10 (first operation), the in-vehicle operation switch 31 notifies the control device 20 of the opening/closing command. In particular, in this example embodiment, a case where an operation to close the window 10 from the fully open state to the fully closed state is input into the in-vehicle operation switch 31 will be described. This example embodiment covers, as will be described later, a case where an automatic closing operation that is an operation to close the window 10 automatically from the fully open state to the fully closed state is input into the in-vehicle operation switch 31, and a case where a manual closing operation that is an operation to close the window 10 manually from the fully open state to the fully closed state is input, and further covers a case where an operation to close the window 10 from a half-open state that is partially closed to the fully closed state is input.

The portable operation switch 32 is composed of a mobile terminal having a short-range wireless communication function, and can be carried outside the vehicle 1 by the operator. The portable operation switch 32 is equipped with a switch for the operator to perform the operation to open/close the window 10 and, when accepting input of an opening/closing command through the operation by the operator to the corresponding window 10 (second operation), outputs the opening/closing command to the control device 20 by short-range wireless communication. That is to say, the portable operation switch 32 can output a command to open/close the window 10 to the control device 20 from outside the vehicle 1. In particular, in this example embodiment, a case where an operation to close the window 10 from the fully open state to the fully closed state is input into the portable operation switch 32 will be described. This example embodiment covers, as will be described later, a case where an automatic closing operation that is an operation to close the window 10 automatically from the fully open state to the fully closed state is input into the portable operation switch 32, or a case where a manual closing operation that is an operation to close the window 10 manually from the fully open state to the fully closed state is input, and further covers a case where an operation to close the window 10 from a half-open state that is partially closed to the fully closed state is input. The portable operation switch 32 is, for example, a mobile device such as a smart key and a smartphone that remotely locks and unlocks the door lock.

The on-board devices 40 are devices that are mounted on the vehicle 1 and can detect the state of the vehicle 1. For example, the on-board devices 40, which are a vehicle speed sensor, a transmission shift lever and a side brake, acquire vehicle state signals representing the state of the vehicle 1 such as vehicle speed, a transmission shift lever position and a side brake state, respectively, and notify the control device 20. The abovementioned on-board devices 40 are merely examples, and may be any device that can detect the state of the vehicle 1.

The control device 20 is configured with an information processing device including an arithmetic logic unit and a memory unit. The control device 20 includes a window operation command acquiring unit 21, a window drive control unit 22, and a vehicle state signal acquiring unit 23 as shown in FIG. 2. The respective functions of the window operation command acquiring unit 21, the window drive control unit 22, and the vehicle state signal acquiring unit 23 are realized by execution of a program stored in the memory unit by the arithmetic logic unit. The control device 20 also includes a window control information storing unit 24 as shown in FIG. 2. The window control information storing unit 24 is composed of the memory unit. The respective components will be described in detail below.

The window control information storing unit 24 stores window control information representing the content of control at the time of opening and closing the window 10. In particular, in this example embodiment, the window control information storing unit 24 stores window control information specifying a drive speed with respect to the open/closed position of the window 10 at the time of closing the window 10. An example of the window control information stored in the window control information storing unit 24 is shown in FIGS. 3 to 5.

The upper view of FIG. 3 is a view showing a range of the open/closed position of the window 10, that is, a section where the top end of the window 10 is located. As shown in this view, as the open/closed position of the window 10, an opening section R1 from the vicinity of the fully open position, namely, a position in the fully open state to a position where the window is closed by a predetermined distance, a closing section R3 from the vicinity of the fully closed position, namely, a position from a position in the fully closed state to a position where the window is open by a predetermined distance before fully closed, and an intermediate section R2 (first section) that is a position other than the above are set. That is to say, the intermediate section R2 is located on a side where the window 10 opens more than the closing section R3, and is located between the opening section R1 and the closing section R3. The intermediate section R2 shall be a wider section than both the opening section R1 and the closing section R3.

Then, the window control information includes, as shown in the lower view of FIG. 3 and FIGS. 4 and 5, information specifying speeds for the respective sections R1, R2 and R3 indicating the open/closed positions of the window 10. Among them, the lower view of FIG. 3 represents first window control information applied when an operation command to close the window 10 is accepted from the abovementioned in-vehicle operation switch 31 (first operation). That is to say, the first window control information defines a window drive speed for in-vehicle operation that is applied when an operator in the vehicle 1 inputs an operation command to close the window 10 from inside the vehicle 1. Specifically, as shown in the lower view of FIG. 3, the first window control information defines a closing speed so as to gradually become faster from a stopped state and reach a first speed V1 in the opening section R1 from the fully open state to the beginning of closing, and define the speed so as to close at the constant first speed V1 in the intermediate section R2. Then, the first window control information defines the speed so as to gradually decrease from the first speed V1 toward the fully closed state and reach a second speed V2 lower than the first speed V1 in the closing section R3 to be the fully closed state, and defines the speed so as to thereafter be in the fully closed state at the constant second speed V2.

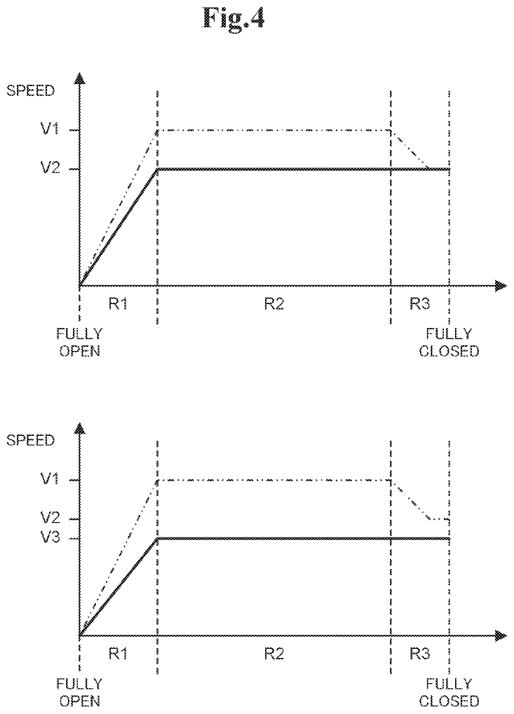

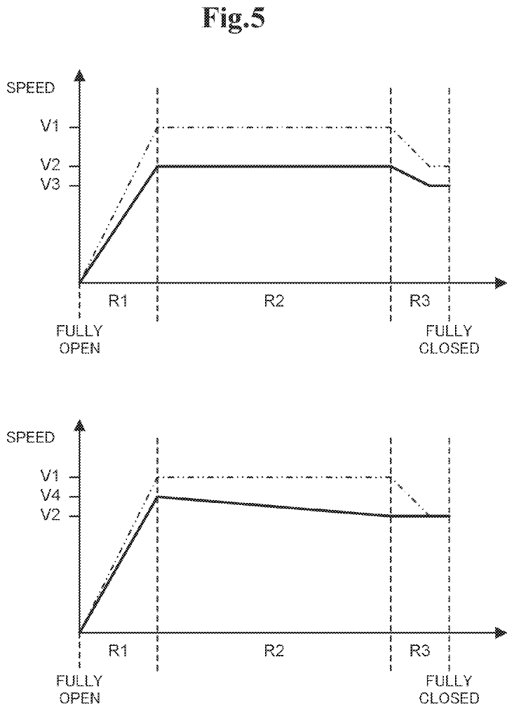

Next, the window control information shown in FIGS. 4 and 5 will be described. Each of the window control information shown in FIGS. 4 and 5 is second window control information applied when an operation command to close the window 10 is accepted from the abovementioned portable operation switch 32 (second operation). That is to say, the second window control information defines a window drive speed for mobile operation that is applied when an operator who is not in the vehicle 1 inputs an operation command to close the window 10 from outside the vehicle 1. The second window control information shown in the upper views and lower views of FIGS. 4 and 5 are second window control information of different patterns from each other, respectively.

Specifically, the second window control information shown in the upper view of FIG. 4 defines that, in the opening section R1 where the window begins to close from the fully open state, a speed to close gradually becomes faster from the stopped state and reaches the second speed V2 that is lower than the first speed V1 mentioned above and, in the subsequent intermediate section R2 and closing section R3, the speed is set so as to close at the constant second speed V2 up to the fully closed state. Thus, the second window control information in the example in the upper view of FIG. 4 defines the speed in the intermediate section R2 and closing section R3 to be constant at a speed that is lower than the first speed V1 set in the intermediate section R2 of the first window control information and identical to the second speed V2 set in the closing section R3. Moreover, the second window control information shown in the lower view of FIG. 4 defines that, in the opening section R1 where the window begins to close from the fully open state, the speed to close gradually becomes faster from the stopped state and reaches a third speed V3 that is lower than the abovementioned second speed V2 and, in the subsequent intermediate section R2 and closing section R3, the speed is set so as to close at the constant third speed V3 up to the fully closed state. Thus, the second window control information in the example in the lower view of FIG. 4 defines the speed in the intermediate section R2 and closing section R3 to be constant at the third speed V3 that is lower than the first speed V1 set in the intermediate section R2 of the first window control information and lower than the second speed V2 set in the closing section R3. Consequently, motor control in a predetermined section can be simplified, and the difficulty in the control design can be reduced. In addition, the need for constantly monitoring the position of the window is eliminated, which can contribute to cost reduction. The speed in the intermediate section R2 and the closing section R3 of the second window control information may be any speed as long as it is lower than the first speed V1 set in the intermediate section R2 of the first window control information.

Further, the second window control information shown in the upper view of FIG. 5 defines that, in the opening section R1 where the window begins to close from the fully open state, a speed to close gradually becomes faster from the stopped state and reaches a second speed V2 that is lower than the abovementioned first speed V1 and, in the subsequent intermediate section R2, the speed is set so as to close at the constant second speed V2. Then, the second window control information defines that, in the closing section R3 up to the fully closed state, the speed gradually decreases from the second speed V2 toward the fully closed state position, reaches a third speed V3 that is lower than the second speed V2, and is then kept at the constant third speed V3 up to the fully closed state. Thus, the second window control information in the example in the upper view of FIG. 4 defines the speed in the intermediate section R2 to be constant at the second speed V2 that is lower than the first speed V1 set in the intermediate section R2 of the first window control information, and the speed in the closing section R3 to be a further lower speed. That is to say, the speeds in the intermediate section R2 and the closing section R3 of the second window control information do not necessarily need to be constant. The speed in the intermediate section R2 of the second window control information may be any speed as long as it is lower than the first speed V1 set in the intermediate section R2 of the first window control information.

Further, the second window control information shown in the lower view of FIG. 5 defines that, in the opening section R1 where the window begins to close from the fully open state, a speed to close gradually becomes faster from the stopped state and reaches a fourth speed V4 that is lower than the abovementioned first speed V1 and, in the intermediate section R2, the speed gradually becomes slower and reaches the abovementioned second speed V2 that is lower than the fourth speed V4. Then, the second window control information defines that, in the closing section R3 up to the fully closed state, the speed is set at the constant second speed V2 up to the fully closed state. Thus, the second window control information in the example in the lower view of FIG. defines the speed in the intermediate section R2 to be a speed that is lower than the first speed V1 set in the intermediate section R2 of the first window control information, and particularly, defines the speed to gradually decrease toward the closing direction. That is to say, the speed in the intermediate section R2 of the second window control information do not necessarily need to be constant. The speed of the intermediate section R2 in the second window control information is not necessarily limited to gradually becoming lower toward the closing direction, and may be set to any speed as long as it is lower than the first speed V1 set in the intermediate section R2 of the first window control information. Moreover, the minimum speed in the intermediate section R2 of the second window control information is not necessarily limited to the abovementioned second speed V2, and may be any speed. Furthermore, the speed in the closing section R3 of the second window control information is not limited to the abovementioned second speed V2, and is not necessarily limited to being constant.

The window operation command acquiring unit 21 acquires commands to open and close the window 10 from the in-vehicle operation switch 21 and the portable operation switch 32 as described above. In particular, in this example embodiment, the window operation command acquiring unit 21 acquires the abovementioned automatic closing operation command as a command to close the window 10 from the fully open state to the fully closed state. However, the window operation command acquiring unit 21 may acquire the abovementioned manual closing operation command, or may acquire an operation command to close from the half open state to the fully closed state.

Upon acquiring a command to open/close the window 10 as described above, the window drive control unit 22 controls the drive unit 11 to drive and performs control to open/close the window 10. In particular, in this example embodiment, upon acquiring a command to close the window 10, the window drive control unit 22 performs control to close the window 10 in accordance with the window control information stored in the window control information storing unit 24 described above. Specifically, when acquiring a command to close the window 10, for example, an automatic closing operation command from the in-vehicle operation switch 31, the window drive control unit 22 performs control to close the window 10 in accordance with the first window control information shown in the lower view of FIG. 3 (first drive control). That is to say, in this case, since the window drive control unit 22 has acquired a command to close the window from an operator in the vehicle, the window drive control unit 22 controls in accordance with the first window control information that defines a drive speed for in-vehicle operation. On the other hand, when acquiring a command to close the window 10, for example, an automatic closing operation command from the portable operation switch 32, the window drive control unit 22 performs control to close the window 10 in accordance with any of the second window control information shown in FIGS. 4 and 5 (second drive control). That is to say, in this case, since the window drive control unit 22 has acquired a command to close the window 10 from an operator outside the vehicle, the window drive control unit 22 controls in accordance with the second window control information that defines a drive speed for mobile operation.

In the case of acquiring the abovementioned manual closing operation and in the case of acquiring a command to operate so as to close from the half open state to the fully closed state, the window drive control unit 22 also performs control to close the window in accordance with the window control information in the same manner as described above. At this time, for example, the window drive control unit 22 compares the position of the window 10 at the moment with the sections of the window in the window control information, and controls so as to close the window 10 at the corresponding drive speed of the window driving device.

In addition to when acquiring a command to close the window 10 from the portable operation switch 32 as described above, when the vehicle 1 is in the stopped state, the window drive control unit 22 may also perform control of the window 10 in the same manner as described above (second drive control). Specifically, the window drive control unit 22 acquires a vehicle state signal, such as the vehicle speed of the vehicle 1, the position of the transmission shift lever and the state of the side brake, acquired by the vehicle state signal acquiring unit 23. The vehicle state signal acquiring unit 23 acquires a vehicle state signal such as the speed of the vehicle, the position of the transmission shift lever and the state of the side brake from the vehicle speed sensor, the transmission shift lever and the side brake that are the on-board devices 40, at constant time intervals or in response to a request from the window drive control unit 22, and notifies the window drive control unit 22. Then, the window drive control unit 22 determines whether or not the vehicle 1 is in the stopped state based on the acquired vehicle state signal. For example, in a case where the vehicle speed is “0”, the position of the transmission shift lever is “P (parking)” and the state of the side brake is “ON”, the window drive control unit 22 determines that the vehicle 1 is in the stopped state. In the case of determining that the vehicle 1 is in the stopped state when acquiring a command to close the window 10 from the portable operation switch 32, the window drive control unit 22 performs control to close the window 10 in accordance with any of the second window control information shown in FIGS. 4 and 5. On the other hand, in the case of determining that the vehicle 1 is not in the stopped state, even if acquiring a command to close the window 10 from the portable operation switch 32, the window drive control unit 22 does not perform control to close the window 10.

The acquisition of the vehicle state signal as described above makes it possible to, for example, perform a window opening/closing operation even when the engine of the vehicle is not operating and make the interior room space of the vehicle more comfortable.

The window drive control unit 22 is not limited to determining that the vehicle 1 is in the stopped state when the vehicle state signal indicates the values as described above, and may also determine that the vehicle is in the stopped state when the vehicle state signal indicates other values. Moreover, the vehicle state signal acquiring unit 23 may acquire a vehicle state signal from a device other than the on-board devices 40 described above, and the window drive control unit 22 may determine that the vehicle 1 is in the stopped state based on any vehicle state signal.

### [Operation]

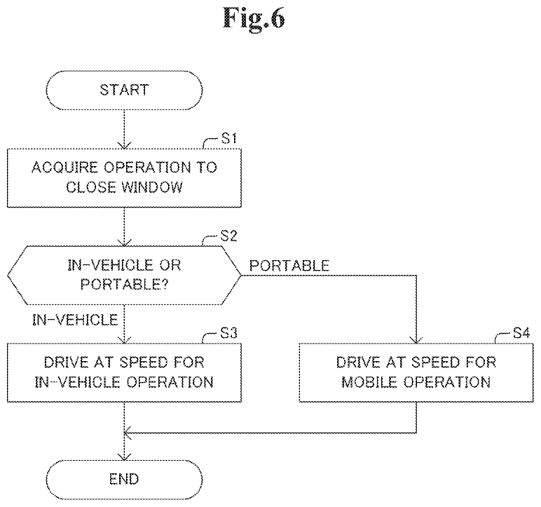

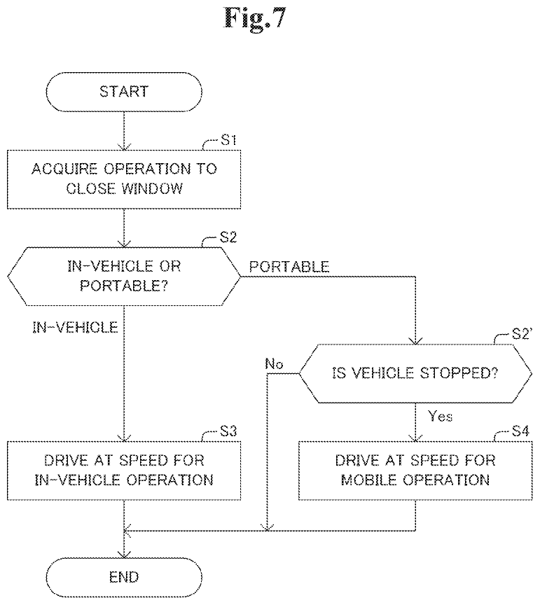

Next, the operation of the window driving device described above, particularly, the operation of the control device 20 will be explained with reference to a flowchart of FIG. 6 or a flowchart of FIG. 7 mainly. First, the operation will be described with reference to the flowchart of FIG. 6.

The control device 20 acquires a command to close the window 10 from the in-vehicle operation switch 31 or the portable operation switch 32 (step S1). At this time, in the case of acquiring the command to close the window 10 from the in-vehicle operation switch 31 (“in-vehicle” at step S2), the control device 20 performs control to close the window 10 in accordance with the first window information that defines a drive speed for in-vehicle operation as shown in the lower view of FIG. 3 (step S3). On the other hand, in the case of acquiring the command to close the window 10 from the portable operation switch 32 (“portable” at step S2), the control device 20 performs control to close the window 10 in accordance with any of the second window control information defining a drive speed for mobile operation as shown in FIGS. 4 and 5 (step S4).

Next, another operation example will be described with reference to the flowchart of FIG. 7. This operation example is different from the above operation in the operation in the case of acquiring a command to close the window 10 from the portable operation switch 32. Specifically, in the case of acquiring a command to close the window 10 from the portable operation switch 32 (“portable” at step S2), the control device 20 further determines whether the vehicle is in the stopped state based on a vehicle state signal (step S2′). Then, in a case where the vehicle 1 is in the stopped state (Yes at step S2′), the control device 20 performs control to close the window 10 in accordance with any of the second window control information defining a drive speed for mobile operation as shown in FIGS. 4 and 5 (step S4). On the other hand, in a case where the vehicle 1 is not in the stopped state (No at step S2′), the control device 20 does not perform control to close the window 10.

As described above, when the window driving device according to this example embodiment accepts an operation to close the window from outside the vehicle 1, the window driving device drives and controls at a lower speed than when accepting an operation to close from inside the vehicle and closing the window. In particular in this example embodiment, in the intermediate section R2 located on the opening side of the closing section R3 in the vicinity where the window is fully closed as shown in FIGS. 3 to 5, the window driving device controls at a speed lower than the first speed V1 for in-vehicle operation (for example, the constant second speed V2 or third speed V3, or a speed that gradually decreases from the fourth speed V4). That is to say, the window driving device controls to the window 10 at a lower speed than in a section where the window is widely open. For this reason, although the operator may not be able to sufficiently check the window during remote operation, it is possible to effectively limit the occurrence of pinching by setting the low-speed section wider. As a result, it is possible to further increase safety during remote operation of the window 10.

Although the present invention has been described above with reference to the example embodiment and the like, the present invention is not limited to the above example embodiment. The configurations and details of the present invention can be changed in various manners that can be understood by one skilled in the art within the scope of the present invention.

### <Supplementary Notes>

The whole or part of the example embodiment disclosed above can be described as the following supplementary notes. Below, the overview of a window driving device and a window drive control method according to the present invention will be described. However, the present invention is not limited to the following configurations.

### (Supplementary Note 1)

A window driving device comprising:
a driving device configured to drive a window mounted on a vehicle to open and close; and
a control device configured to control the opening and closing drive on the window by the driving device,
wherein the control device is configured to:
when a first operation to close the window is performed with an operation device located inside the vehicle, perform first drive control including drive control to close the window at a constant first speed in a first section located on an opening side more than a closing section located near a fully closed position of the window, and drive control to close the window at a lower speed than the first speed in the closing section; and
when a second operation to close the window is performed with an operation device that can be carried outside the vehicle, perform second drive control including drive control to close the window at a lower speed than the first speed in the first section.

### (Supplementary Note 2)

The window driving device according to Supplementary Note 1, wherein
the control device is configured to, when performing the second drive control, perform drive control to close the window at a constant speed lower than the first speed in the first section.

### (Supplementary Note 3)

The window driving device according to Supplementary Note 1, wherein
the control device is configured to, when performing the second drive control, perform drive control to close the window at a constant speed lower than the first speed in the first section and the closing section.

### (Supplementary Note 4)

The window driving device according to Supplementary Note 3, wherein
the control device is configured to, when performing the second drive control, perform drive control to close the window in the first section and the closing section at a constant speed identical to the speed for the closing section at time of performing the first drive control.

### (Supplementary Note 5)

The window driving device according to Supplementary Note 3, wherein
the control device is configured to, when performing the first drive control, perform drive control to close in the closing section at a higher speed than the speed at time of performing the second drive control.

### (Supplementary Note 6)

The window driving device according to Supplementary Note 3, wherein
the control device is configured to, when performing the second drive control, perform drive control to close the window at a constant speed lower than the first speed, in the first section and the closing section that are equivalent to a remaining section excluding an opening section located near a fully open position of the window.

### (Supplementary Note 7)

The window driving device according to Supplementary Note 1, wherein
the control device is configured to perform the second drive control when a vehicle state signal representing a state of the vehicle detected from the vehicle is a previously set value and the second operation is performed.

### (Supplementary Note 8)

The window driving device according to Supplementary Note 7, wherein
the control device is configured to perform the second drive control when the vehicle state signal is a value representing that the vehicle is stopped and the second operation is performed.

### (Supplementary Note 9)

The window driving device according to Supplementary Note 8, wherein
the control device is configured to perform the second drive control when at least one of values of a transmission shift lever position, a side brake status, and a vehicle speed is the value representing that the vehicle is stopped and the second operation is performed.

### (Supplementary Note 10)

A window drive control method for controlling opening and closing drive on a window mounted on a vehicle, the window drive control method comprising:
when a first operation to close the window is performed with an operation device located inside the vehicle, performing first drive control including drive control to close the window at a constant first speed in a first section located on an opening side more than a closing section located near a fully closed position of the window, and drive control to close the window at a lower speed than the first speed in the closing section; and
when a second operation to close the window is performed with an operation device that can be carried outside the vehicle, performing second drive control including drive control to close the window at a lower speed than the first speed in the first section.

### DESCRIPTION OF REFERENCE NUMERALS

1 vehicle
10 window
11 driving device
20 control device
21 window operation command acquiring unit
22 window drive control unit
23 vehicle state signal acquiring unit
24 window control information storing unit
31 in-vehicle operation switch
32 portable operation switch
40 on-board device

1. A window driving device comprising:
a driving device configured to drive a window mounted on a vehicle to open and close; and
a control device configured to control the opening and closing drive on the window by the driving device,
wherein the control device is configured to:
when a first operation to close the window is performed with an operation device located inside the vehicle, perform first drive control including drive control to close the window at a constant first speed in a first section located on an opening side more than a closing section located near a fully closed position of the window, and drive control to close the window at a lower speed than the first speed in the closing section; and
when a second operation to close the window is performed with an operation device that can be carried outside the vehicle, perform second drive control including drive control to close the window at a lower speed than the first speed in the first section.

2. The window driving device according to claim 1, wherein
the control device is configured to, when performing the second drive control, perform drive control to close the window at a constant speed lower than the first speed in the first section.

3. The window driving device according to claim 1, wherein
the control device is configured to, when performing the second drive control, perform drive control to close the window at a constant speed lower than the first speed in the first section and the closing section.

4. The window driving device according to claim 3, wherein
the control device is configured to, when performing the second drive control, perform drive control to close the window in the first section and the closing section at a constant speed identical to the speed for the closing section at time of performing the first drive control.

5. The window driving device according to claim 3, wherein
the control device is configured to, when performing the first drive control, perform drive control to close in the closing section at a higher speed than the speed at time of performing the second drive control.

6. The window driving device according to claim 3, wherein
the control device is configured to, when performing the second drive control, perform drive control to close the window at a constant speed lower than the first speed, in the first section and the closing section that are equivalent to a remaining section excluding an opening section located near a fully open position of the window.

7. The window driving device according to claim 1, wherein
the control device is configured to perform the second drive control when a vehicle state signal representing a state of the vehicle detected from the vehicle is a previously set value and the second operation is performed.

8. The window driving device according to claim 7, wherein
the control device is configured to perform the second drive control when the vehicle state signal is a value representing that the vehicle is stopped and the second operation is performed.

9. The window driving device according to claim 8, wherein
the control device is configured to perform the second drive control when at least one of values of a transmission shift lever position, a side brake status, and a vehicle speed is the value representing that the vehicle is stopped and the second operation is performed.

10. A window drive control method for controlling opening and closing drive on a window mounted on a vehicle, the window drive control method comprising:
when a first operation to close the window is performed with an operation device located inside the vehicle, performing first drive control including drive control to close the window at a constant first speed in a first section located on an opening side more than a closing section located near a fully closed position of the window, and drive control to close the window at a lower speed than the first speed in the closing section; and
when a second operation to close the window is performed with an operation device that can be carried outside the vehicle, performing second drive control including drive control to close the window at a lower speed than the first speed in the first section.
